(19) United States
(12) Patent Application Publication
(10) Pub. No.: US 2005/0172894 A1
(43) Pub. Date: Aug. 11, 2005

(54) Selective deposition system and method for initiating deposition at a defined starting surface

(76) Inventor: Warren M. Farnworth, Nampa, ID (US)

Correspondence Address: TRASK BRITT, P.O. BOX 2550, SALT LAKE CITY, UT, 84110, US

(21) Appl. No.: 10/775,351

(22) Filed: Feb. 10, 2004

(51) Int. Cl. B05C 5/00; B05B 13/04; B05C 11/00

(52) U.S. Cl. 118/712; 118/663; 118/665; 118/320

(57) ABSTRACT

A selective deposition system and method for initiating deposition of an unconsolidated material at a defined starting surface are disclosed. The system includes a sensor system for measuring an upper surface of a workpiece and a surface level of the unconsolidated material as deposited on the upper surface of the workpiece. The deposition process and measurement of the upper surface of the material on the workpiece are continuously performed as the material is applied in a layer by layer deposition process resulting in a substantially uniform material of a predetermined thickness beginning at the upper surface of the workpiece.

### BACKGROUND OF THE INVENTION

1. Field of the Invention

The present invention relates generally to systems and associated methods for forming three-dimensional objects on or about a defined starting surface. More particularly, the present invention relates to correlating the beginning surface of a workpiece with a surface level of a selective deposition system and method.

2. Background of Related Art

Various selective deposition processes exist and have become well defined in the art. One exemplary selective deposition manufacturing technique termed “stereolithography,” also known as “layered manufacturing,” has evolved to a degree where it is employed in many industries. Essentially, stereolithography as conventionally practiced involves utilizing a computer to generate a three-dimensional (3-D) mathematical simulation or model of an object to be fabricated, such generation usually effected with 3-D computer-aided design (CAD) software. The model or simulation is mathematically separated or “sliced” into a large number of relatively thin, parallel, usually vertically superimposed layers, each layer having defined boundaries and other features associated with the model (and thus the actual object to be fabricated) at the level of that layer within the exterior boundaries of the object. A complete assembly or stack of all of the layers defines the entire object, and surface resolution of the object is, in part, dependent upon the thickness of the layers.

The mathematical simulation or model is then employed to generate an actual object by building the object, layer by superimposed layer. A wide variety of approaches to stereolithography by different companies has resulted in techniques for fabrication of objects from both metallic and non-metallic materials. Regardless of the material employed to fabricate an object, stereolithographic techniques usually involve disposition of a layer of unconsolidated or unfixed material corresponding to each layer within the object boundaries, followed by selective consolidation or fixation of the material to at least a partially consolidated, or semisolid, state in those areas of a given layer corresponding to portions of the object, the consolidated or fixed material also at that time being substantially concurrently bonded to a lower layer of the object to be fabricated. The unconsolidated material employed to build an object may be supplied in particulate or liquid form, and the material itself may be consolidated or fixed, or a separate binder material may be employed to bond material particles to one another and to those of a previously formed layer.

In some instances, thin sheets of material may be superimposed to build an object, each sheet being fixed to a next lower sheet and unwanted portions of each sheet removed, a stack of such sheets defining the completed object. When particulate materials are employed, resolution of object surfaces is highly dependent upon particle size, whereas when a liquid is employed, surface resolution is highly dependent upon the minimum surface area of the liquid which can be fixed and the minimum thickness of a layer that can be generated. Of course, in either case, resolution and accuracy of object reproduction from the CAD file is also dependent upon the ability of the apparatus used to fix the material to precisely track the mathematical instructions indicating solid areas and boundaries for each layer of material. Toward that end, and depending upon the layer being fixed, various fixation approaches have been employed, including particle bombardment (electron beams), disposing a binder or other fixative (such as by ink-jet printing techniques), or irradiation using heat or specific wavelength ranges.

An early application of stereolithography was to enable rapid fabrication of molds and prototypes of objects from CAD files. Thus, either male or female forms on which mold material might be disposed may be rapidly generated. Prototypes of objects might be built to verify the accuracy of the CAD file defining the object and to detect any design deficiencies and possible fabrication problems before a design was committed to large-scale production.

In more recent years, stereolithography has been employed to develop and refine object designs in relatively inexpensive materials, and has also been used to fabricate small quantities of objects where the cost of conventional fabrication techniques is prohibitive for same, such as in the case of plastic objects conventionally formed by injection molding. It is also known to employ stereolithography in the custom fabrication of products generally built in small quantities or where a product design is rendered only once. Finally, it has been appreciated in some industries that stereolithography provides a capability to fabricate products, such as those including closed interior chambers or convoluted passageways, which cannot be fabricated satisfactorily using conventional manufacturing techniques.

Stereolithography has been applied to mass production of articles in volumes where minute component sizes are involved, and where extremely high resolution and a high degree of reproducibility of results is required. By way of example, conventional stereolithography relating to semiconductor processing has been identified by the assignee and various aspects of packaging devices using such techniques are described in various patents, for example, in U.S. Pat. No. 6,524,346, U.S. Pat. No. 6,549,821, U.S. Pat. No. 6,537,482, U.S. Pat. No. 6,544,465, U.S. Pat. No. 6,529,027 and U.S. Pat. No. 6,326,698 and assigned to the assignee of the invention disclosed and claimed herein, which references are further incorporated herein by reference. In particular, while stereolithography has been used to fabricate encapsulating structures or partially encapsulating structures, the formation of a structure on or about a workpiece beginning at a predefined location has not been described.

One particular technology that, in the future, may particularly benefit from such an advancement includes the art of semiconductor packaging. Semiconductor devices, such as memory devices and processors, are generally fabricated in very large numbers. Typically, several semiconductor devices are fabricated on a wafer or other large-scale substrate that includes a layer of semiconductor material (e.g., silicon, gallium arsenide, or indium phosphide). The semiconductor devices are then singulated, or diced, from the wafer or other large-scale substrate to provide semiconductor “chips” or dice.

Conventionally, semiconductor dice have been packaged for protection and to facilitate the formation of electrical connections to the small bond pads thereof. Conventional semiconductor device packages typically include an assembly of a semiconductor die and a higher level substrate board (e.g., a circuit board) or leads. Bond pads of the semiconductor die are electrically connected (e.g., by wire bonds or otherwise) to contact pads of a higher level substrate or to leads. The assembly may then be packaged. For example, assemblies that include a semiconductor die with leads connected to the bond pads thereof are typically packaged by use of transfer molding techniques to secure the leads in place and to protect the active surface of the semiconductor die and the wire bonds or other intermediate conductive elements. Assemblies including a semiconductor die and a higher level substrate may be packaged by injection molding techniques or with a glob-top type encapsulant, both of which protect the active surface of the semiconductor die and the wire bonds or other intermediate conductive elements.

Due to the ever-decreasing sizes of state of the art electronic devices, conventional semiconductor device packages are relatively bulky. As a result, alternative semiconductor device packaging configurations have been developed to reduce the amount of area, or “real estate,” on circuit boards consumed by semiconductor device packages.

Among these state of the art semiconductor device packages are the so-called chip-scale packages, the areas of which are substantially the same as or only slightly larger than the areas of the semiconductor dice thereof. Chip-scale packages may include a semiconductor die and an interposer superimposed over the semiconductor die. The bond pads of the semiconductor die are electrically connected to contact pads of the interposer, which are in turn electrically connected to a circuit board or other carrier substrate through traces extending to other contact elements that mate with terminals on the circuit board or other carrier substrate.

An exemplary ball grid array type chip-scale package 201 is illustrated in FIG. 1. Package 201 includes a semiconductor die 202 and an interposer 206 positioned over an active surface 203 of semiconductor die 202. Interposer 206 is secured to semiconductor die 202 with a layer 215 of adhesive material. A quantity of underfill material 216 is introduced between semiconductor die 202 and interposer 206 to fill any remaining open areas therebetween.

Interposer 206 includes a slot 207 formed therethrough. Bond pads 204 on an active surface 203 of semiconductor die 202 are exposed through slot 207. Bond pads 204 are connected by way of wire bonds 205 or other intermediate conductive elements to corresponding first contact pads 208 on interposer 206. As illustrated, wire bonds 205 extend through slot 207. Each first contact pad 208 communicates with a corresponding second contact pad 209 on interposer 206 by way of a conductive trace 210 carried by interposer 206. Second contact pads 209 may be arranged so as to reroute the output locations of bond pads 204. Thus, the locations of second contact pads 209 may also impart interposer 206 with a desired footprint, and particularly one which corresponds to the arrangement of terminal pads on a carrier substrate (not shown) to which package 201 is to be connected. Bond pads 204, wire bonds 205, and first contact pads 208 have each previously been protected by a quantity of an encapsulant material 211.

Package 201 is electrically connected to a carrier substrate by way of conductive structures 213, such as solder balls, connected to second contact pads 209 and corresponding contact pads of the carrier substrate. Package 201 is configured to be connected to a carrier substrate in an inverted, or flip-chip, fashion, which conserves real estate on the carrier substrate. It is also known in the art to connect a chip-scale package to a carrier substrate by way of wire bonds or other conductive elements. Such assemblies, packages and interposers are disclosed, for example, in U.S. Pat. No. 5,719,440, issued to Walter L. Moden and assigned to the assignee of the invention disclosed and claimed herein.

In addition to encapsulating the interconnections between bond pads 204 of die 202 and contact pads 208 of interposer 206, it may also be desirable to further encapsulate other facets of chip scale package 201 including side and bottom surfaces. Suitable encapsulation techniques must be precisely applied and controlled in order to maintain tolerances for subsequent processing steps, an example of which is the application of conductive structures 213. Accordingly, there is a need for a system and method for forming a deposed layer of a determined thickness on one or more facets of an assembly with the selective deposition beginning at a defined starting surface. Furthermore, there is a need for a method and system for sensing a coating thickness and determining a starting and endpoint of a coating process.

### SUMMARY OF THE INVENTION

The present invention is directed to a selective deposition system and method for initiating deposition of a material at an upper surface of a workpiece, an example of which is a semiconductor die integral with a semiconductor wafer. In one embodiment of the present invention, a system for selectively depositing a specific thickness of a material on a previously formed workpiece is disclosed. The system includes a platform for supporting the workpiece during a deposition process, a sensing system for measuring both a level of an upper surface of the workpiece and a surface level of the material deposited on the upper surface of the workpiece until the surface level of the material corresponds to the specific thickness of the material. The system further includes a deposition system for depositing the material on the workpiece to the specific thickness as monitored by the sensing system.

In another embodiment of the present invention, a selective deposition system for depositing a material at selective locations in the X/Y plane, parallel to a major plane of a previously formed workpiece and on the surface thereof is disclosed. The system includes a controller and a platform for moveably supporting in a Z direction, perpendicular to the X/Y plane, the workpiece during a layer by layer deposition of the material at selected locations on the workpiece surface. The system further includes a reservoir for retaining the material into which the platform may be submerged with the workpiece thereon during the layer by layer deposition process. A scanning laser configured to move a laser beam over the workpiece is responsive to the controller and exposes a portion of the material corresponding to the selective locations for a current deposition layer on the workpiece. In order to monitor the thickness and suspend any further deposition processes, at least one sensing system is responsive to the controller for determining a workpiece surface level when the workpiece is supported by the platform and for determining a surface level of the material deposited on the workpiece. It is contemplated that more than one sensing system may be employed.

In a further embodiment of the present invention, a method for selectively depositing a material on a workpiece is disclosed. According to the method, a workpiece is secured to a platform and the level of the top surface of the workpiece is measured to determine a starting point for depositing at least a portion of the material thereon. A portion of the material is deposited on the workpiece and an upper surface of the material as deposited on the workpiece is measured to determine a thickness of the material on the workpiece. The depositing and measuring of the upper surface of the material continues until the thickness of the material corresponds to a preselected thickness.

In a yet additional embodiment of the present invention, a method for fabricating a semiconductor assembly is disclosed. A level of a top surface is measured to determine a deposition starting point of at least one semiconductor die integral with a semiconductor wafer. A layer of an encapsulant material is deposited in a predetermined form beginning at the deposition starting point on the at least one semiconductor die. The level of an upper surface of the layer of the encapsulant material is measured as deposited on the at least one semiconductor die to determined thickness of the material on the at least one semiconductor die. Additional layers of the encapsulant material are deposited until the level of the measured upper surface of the current layer of the encapsulant material substantially equals a predetermined thickness.

Other features and advantages of the present invention will become apparent to those of ordinary skill in the art through consideration of the ensuing description, the accompanying drawings, and the appended claims.

### BRIEF DESCRIPTION OF THE SEVERAL VIEWS OF THE DRAWINGS

FIG. 1 is a cross-sectional view of an exemplary chip-scale package with a partial encapsulant placed over the intermediate conductive elements thereof;

FIG. 2 is a perspective view of a semiconductor wafer including multiple dice having active portions thereon, in accordance with one or more embodiments of the present invention;

FIG. 3 is a cross-sectional view of a semiconductor device of the semiconductor wafer including an interposer and scribe cuts of the semiconductor wafer of FIG. 2, taken along line 3-3 thereof, in accordance with an embodiment of the present invention;

FIG. 4 is a cross-sectional view of a semiconductor device including the assembly of FIG. 3, depicting an encapsulant material disposed over the top surface including the scribe cuts surrounding the semiconductor die, in accordance with an embodiment of the present invention;

FIG. 5 is a cross-sectional view of a semiconductor device including the assembly of FIG. 4, depicting removal of a portion of the back or passive side of the semiconductor wafer, in accordance with an embodiment of the present invention;

FIG. 6 is another cross-sectional view of a semiconductor device package shown in FIG. 5, which includes an encapsulant layer formed over the partially removed back or passive side of the semiconductor device, in accordance with an embodiment of the present invention;

FIG. 7 is another cross-sectional view of the semiconductor device package shown in FIG. 6, as singulated from the semiconductor wafer, in accordance with an embodiment of the present invention;

FIG. 8 is a partial view of a sensing system of an exemplary spin-on system, in accordance with an embodiment of the present invention;

FIG. 9 is a partial view of a sensing system of an exemplary stereolithography system, in accordance with an embodiment of the present invention; and

FIG. 10 is a schematic representation of an exemplary stereolithography apparatus that may be employed in the method of the present invention to fabricate the encapsulant of a semiconductor die, in accordance with an embodiment of the present invention.

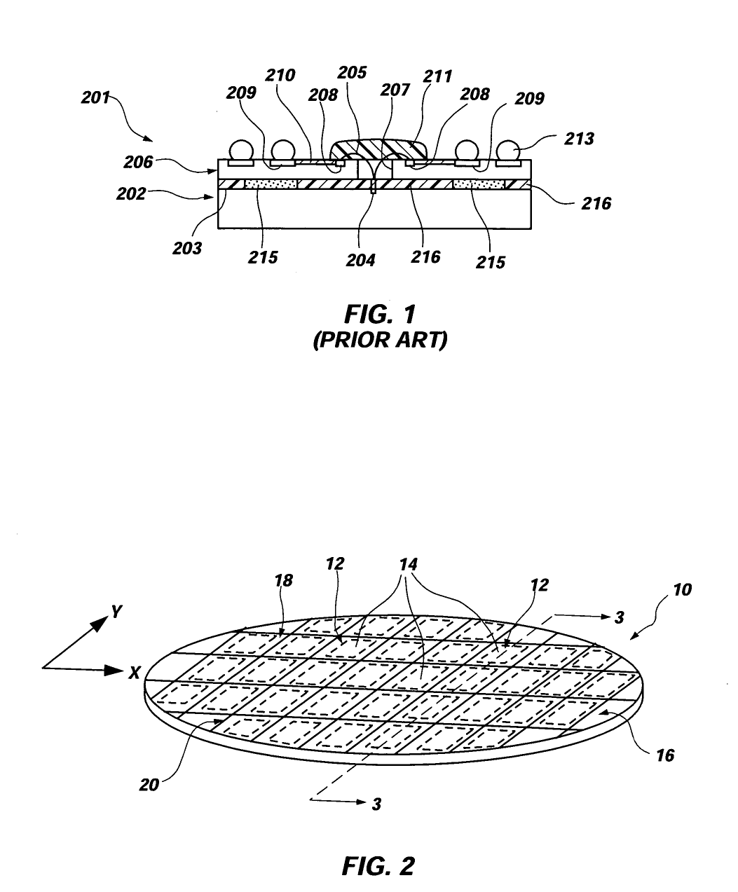

### DETAILED DESCRIPTION OF THE INVENTION

While the present exemplary description is drawn to applications for semiconductor wafers, applications to other electrically active or passive configurations are also contemplated wherein formation of a subsequent structure beginning at a specific surface or location of an existing structure is desired. FIG. 2 illustrates a semiconductor wafer including multiple dice having active portions thereon, in accordance with one or more embodiments of the present invention. A semiconductor wafer 10 includes a plurality of semiconductor dice 12 having corresponding active areas 14 thereon. Typically, semiconductor wafer 10 includes a two-dimensional array-like arrangement of dice 12 across an active surface 16. Accordingly, separation or “singulation” of individual die from the semiconductor wafer includes one or more initial steps for forming scribe cuts 18, 20 in respective X and Y directions along one or more surfaces, such as active surface 16, of the semiconductor wafer 10.

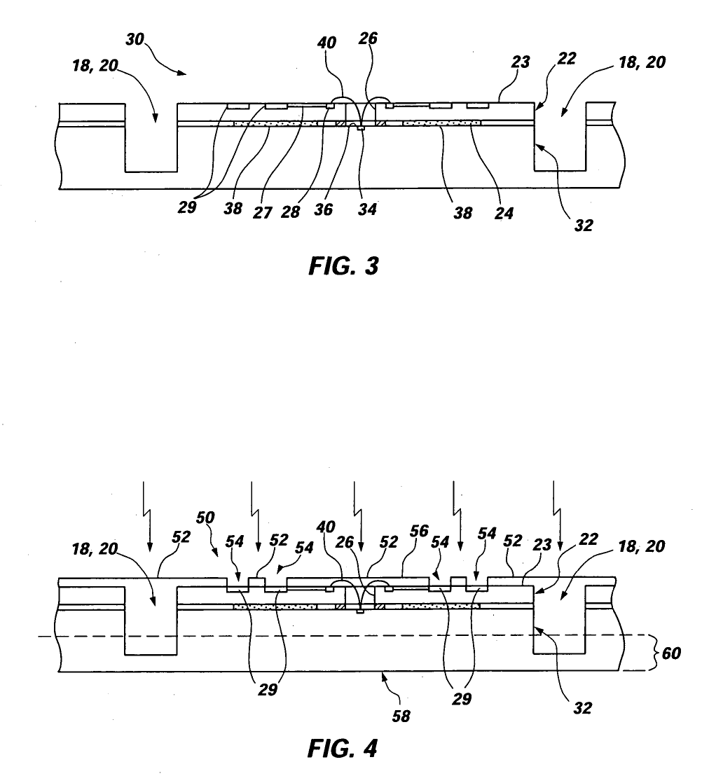

FIG. 3 depicts an assembly 30 including an interposer 22 and a semiconductor die 32 with bond pads 34 positioned on an active surface 36 thereof in, for example, one or more centrally located rows. An interposer 22 is a substantially planar member formed from, for example, semiconductor material (e.g., silicon), or any other known substrate material having a coefficient of expansion (CTE) sufficiently similar to that of the material of the semiconductor die 32 and having an upper surface 23 and a lower surface 24. As illustrated in FIG. 3, interposer 22 includes an elongate slot 26 formed therethrough. Slot 26 is positioned substantially along the center of interposer 22. Interposer 22 also includes first contact pads 28, or contacts, located proximate slot 26. Electrical traces 27 carried by interposer 22 connect each first contact pad 28 to a corresponding second contact pad 29 carried on upper surface 23 of interposer 22. As depicted, second contact pads 29 are arranged in an array over upper surface 23. As illustrated and by way of example and not limitation, two parallel strips of adhesive 38 may be placed between active surface 36 of semiconductor die 32 and lower surface 24 of interposer 22 so as to secure interposer 22 to semiconductor die 32. Intermediate conductive elements 40, which are illustrated as wire bonds but may also be any other known type of intermediate conductive elements, extend through slot 26 to electrically connect bond pads 34 of semiconductor die 32 to corresponding first contact pads 28 of interposer 22.

In order to facilitate encapsulation of assembly 30, an encapsulation material is formed over upper surface 23 of interposer 22 and around the exposed end surfaces of interposer 22 and die 32 as exposed by scribe cuts 18, 20. The encapsulant material may also be formed within slot 26 for the protection and sealing of intermediate conductive elements 40. By way of example and not limitation, the encapsulant material is applied to the assembly 30 through the use of stereolithographic techniques as will be described herein.

FIG. 4 is a cross-sectional view of a semiconductor device including the assembly 30 of FIG. 3, depicting an encapsulant material disposed over the top surface including the scribe cuts surrounding the semiconductor die, in accordance with an embodiment of the present invention. In FIG. 4, an assembly 50 has generally disposed thereon an encapsulant material 52 in an unconsolidated state. By way of example and not limitation, the unconsolidated encapsulant material may be applied to the upper surface 23 as well as the voids formed by the scribe cuts 18, 20 using a spin-on process commonly used for application of photoresist during a semiconductor patterning process or through the use of a stereolithographic process of applying liquefied or otherwise unprocessed or unconsolidated material across the upper surface 23 of assembly 50. Specifics regarding spin-on process are known by those of ordinary skill in the art while the stereolithographic process and an apparatus for performing the process are described in the previously incorporated by reference U.S. patents and further described below.

The assembly 50 undergoes a curing or hardening process for selectively forming in place encapsulant material 52 while retaining apertures 54 for enabling electrical contact with the second contact pads 29. The encapsulant material may also flow into the slot 26 for protection of intermediate conductive elements 40. The curing or hardening process may include a layer-by-layer curing process for all of the layers or may include a two-step process of curing which first fills the various voids with unconsolidated encapsulant material and then caps the uncured encapsulant material with a cured cap. The capped but uncured portion of the encapsulant material is thereafter cured in a follow-up curing step.

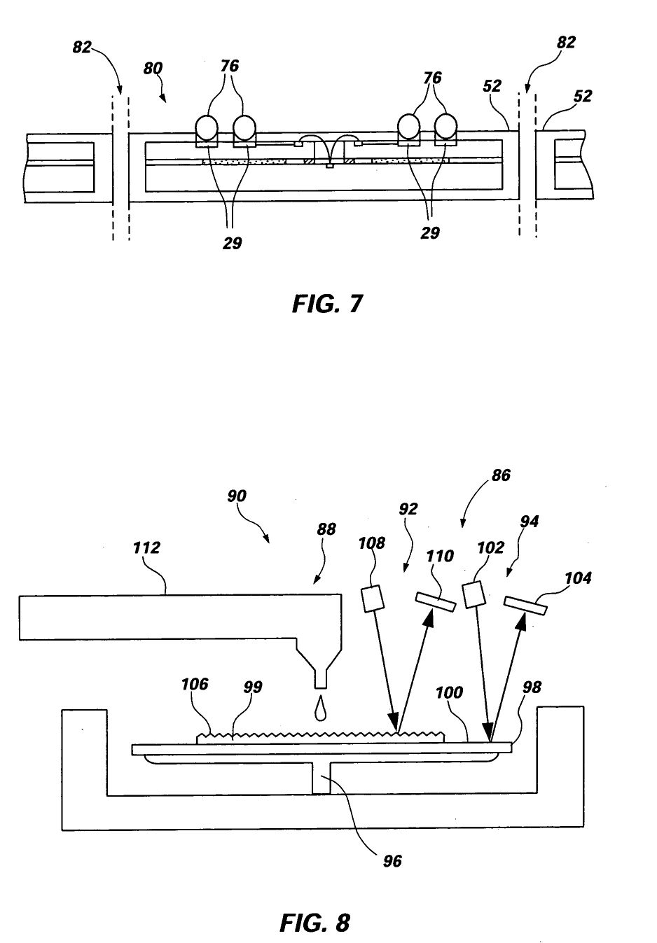

Encapsulant material 52 of assembly 50 exhibits a substantially planar surface 56. Since surface 56 may be substantially planar, the overall thickness of assembly 50 is reduced relative to packages that employ conventional glob-top type encapsulant materials of greater viscosity and thus having convexly curved surfaces. In addition, when surface 56 is substantially planar, encapsulant material 52 is not as likely as a semiconductor device package with a convexly curved glob-top type encapsulant to interfere with the flip-chip connection of conductive contact pins 76 (FIG. 7) to the terminals of a higher level substrate.

To ensure that contacts with, for example, the second contact pads 29 may be of a repeatable and reliable nature, the thickness of the encapsulant material 52 located on the upper surface 23 should be consistently formed. For example, in a “flip chip” configuration utilizing a ball grid array contact methodology, where discrete electrically conductive elements in the form of a ball, bump, stud or pillar contacts of solder, other metals or alloys or conductive or conductive filled polymer are applied to the second contact pads 29, the thickness of the encapsulant material 52 should be controlled in accordance with design specifications to enable proper placement of the electrically conductive ball contacts within apertures 54 and mounting clearance for mounting the final assembly to, for example, a printed circuit board. Prior encapsulation approaches have not measured and monitored the thickness of the encapsulant material with reference to the upper surface 23 of the workpiece such as the semiconductor die 32 of the present example. The encapsulating apparatus disclosed below provides for the measurement location of the upper surface 23 of semiconductor die 32 and the further measurement of the location of the upper surface 56 of the encapsulant material 52.

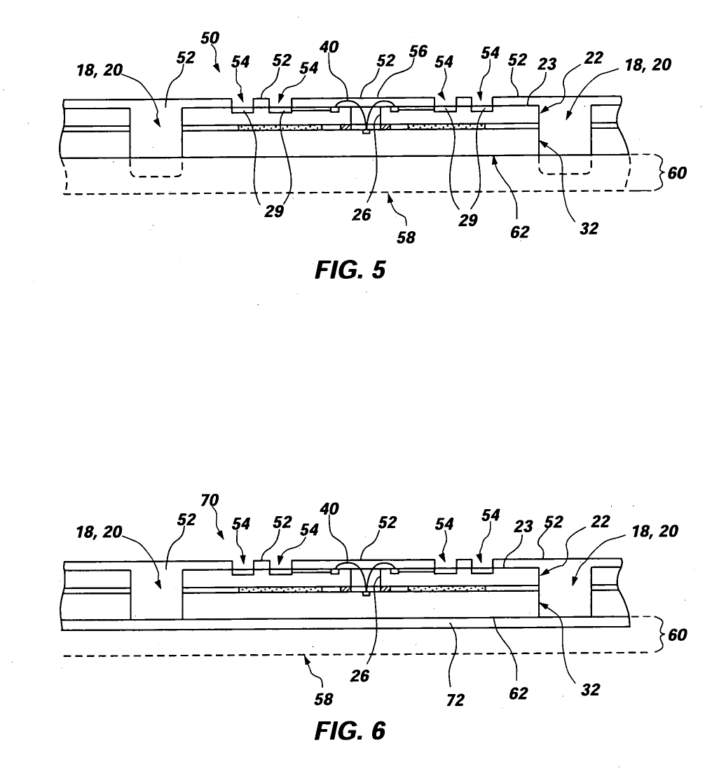

FIG. 5 is a cross-sectional view of a semiconductor device including the assembly of FIG. 4, depicting removal of a portion of the back or passive side of the semiconductor wafer for enabling further encapsulation of the back, or passive, side of the semiconductor wafer having one or more semiconductor die thereon, in accordance with an embodiment of the present invention. On a semiconductor die, active circuitry is generally fabricated only on one side and is largely superficial to that side. Therefore, a portion of the back or passive side 58 may be removed to form a thinned surface 62 through mechanical, chemical or otherwise to a depth 60 which at least corresponds to the thickness of the remaining semiconductor wafer located below the scribe cut 18, 20. Abrasive back-grinding and wet chemical etching are suitable techniques to effect such material removal.

FIG. 6 is another cross-sectional view of a semiconductor device package shown in FIG. 5, which includes an encapsulant layer formed over the partially removed back or passive side of the semiconductor wafer, in accordance with an embodiment of the present invention. In order to further encapsulate an assembly 70, an encapsulant layer 72 is formed on the thinned surface 62 and further couples to the encapsulant material 52 within scribe cuts 18, 20 which surrounds the semiconductor die 32 and the interposer 22, if present within assembly 70. The encapsulant layer 72 may be formed, after inversion of the workpiece, by encapsulation techniques similar to that described above or by more rudimentary techniques such as spin-on techniques, since the thickness dimension of the encapsulation layer 72 generally does not demand as precise tolerances as those structures formed on the active side.

FIG. 7 is a cross-sectional view of the semiconductor device package shown in FIG. 6, of the semiconductor wafer, in accordance with an embodiment of the present invention. Electrically conductive contacts or pins 76 (e.g., balls, bumps, studs, pillars, or other structures formed from metal, conductive polymer, conductor-filled polymer, or other conductive material), are illustrated as electrically conductive ball contacts according to an exemplary ball grid array contact methodology. The pins 76 are applied to the second contact pads 29 followed by a further processing step which singulates an assembly 80 from the semiconductor wafer by performing a narrower scribe cut 82 within the previous scribe cut 18, 20 (FIGS. 2-6) which was subsequently filled with encapsulant material 52.

FIG. 8 is a partial view of a sensing system of an exemplary flowable material spin-on system, in accordance with an embodiment of the present invention. A spin-on thickness characterization system 90 generally in includes (i) a surface level sensory portion 86 for measuring the beginning surface level and monitoring the material surface level and (ii) a material application portion 88 for dispensing and distributing the material. The material application portion 88 includes a dispenser 112 and a support and spinning system 96 for providing support and controlled rotational motion for a workpiece such as semiconductor wafer 98. The surface level sensory portion 86 includes one or more sensors 92, 94 for measuring a level of surface 100 and monitoring changes in the level of surface 106 of a dispensed material 99. The level of an upper surface 100 of semiconductor wafer 98 is measured by, for example, sensor 94 comprised of a transmitter 102 and a receiver 104. The measurement of the upper surface 100 defines a reference point upon which a defined thickness of material 99, such as an encapsulant material, may be dispensed and formed.

The thickness or surface level of material 99 at surface 106 may be measured using the same sensor 94 when placed within a dispensed material region about the semiconductor wafer 98, or, alternatively a dedicated sensor 92 may be employed to measure and monitor the level at surface 106 of material 99. In FIG. 8, the sensor 92 includes a separate transmitter 108 and receiver 110, however, combinations of sensor componentry is also contemplated within the scope of the present invention. The sensors 92, 94 are configured to transmit a signal toward the surfaces 100, 106 and to receive a reflected signal from the respective surfaces. The transmitted signal may be an energy beam selected from the group comprising a visible light beam, an ultra-violet light beam, an infrared light beam, a radio frequency (“RF”) beam, a microwave beam and an ultra-sound beam. To determine the location of the surface defining a starting point such as the surface of the semiconductor wafer or to determine the surface of the upper surface of the material which facilitates the calculation of the thickness of the material, the reflected signal may be analyzed to determine a relative distance between the sensor and the surface.

In one embodiment of the present invention, the relative distance between the sensor and the surface of the semiconductor wafer is derived by measuring the time delay between the emission of the transmitted signal and detection of the reflected signal, multiplying the measured time delay by the speed of the transmitted signal and dividing by two. In another embodiment of the present invention, the distance between the sensor and the surface may be determined by indirectly establishing the time delay by measuring a phase difference between the transmitted signal and the reflected signal. In a phase measurement sensor embodiment, the transmitted signal may comprise a modulated signal. In yet another embodiment of the present invention, the transmitted signal may be a pulsed signal and the reflected pulse signal may be detected only during a predetermined time window such that increased time delay between transmission and detection causes less of the pulse to be detected. Thus, the detected power level of the reflected pulse signal is inversely proportional to the distance traveled. Other embodiments for measuring the distance between the sensor and the surface, as presently known in the art, may also be employed.

Specifically, transmitters 102, 108 operate as source elements configured to generate, for example, collimated light beams. By way of example and not limitation, the transmitter may comprise a laser diode. Alternatively, the transmitter may comprise a collimator, such as a lens, configured to collimate or focus light exiting an optical fiber to a desired beam diameter or spot size. The collimated light emitted from the transmitter minimizes extraneous reflections and enhances signal detection. Use of a collimated light beam as an energy beam is currently preferred, although the invention is not so limited.

The receivers 104, 1 10 comprise a plurality of detectors disposed in an array, for example a linear array, wherein the detectors are spatially distributed according to the resolution and thickness of material 99. Each detector in the receivers 104, 110 is configured to produce an electronic sensory signal related to the magnitude of the radiation received thereon. By way of example and not limitation, each detector may comprise a photodiode or a charge coupled device (“CCD”). Alternatively, each detector in the receiver may comprise a collimator, such as a lens, configured to collect light into an optical fiber.

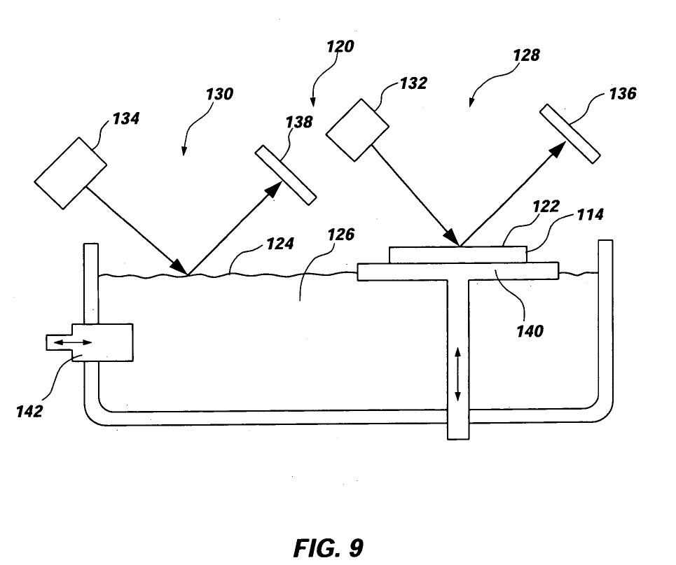

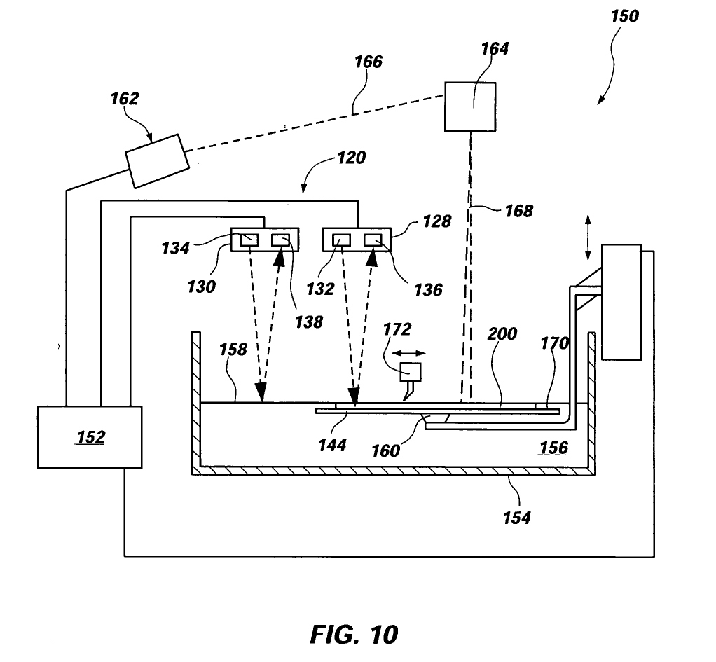

FIGS. 9 and 10 depict various components, and operation, of an exemplary stereolithography apparatus, in accordance with various embodiments of the present invention. FIG. 9 is a partial view of a sensing system 120 of an exemplary stereolithography system in which a workpiece, such as a semiconductor wafer 114, may undergo application of a measurable thickness of an unconsolidated material, such as an encapsulant material. The sensing system 120 measures both the starting position or level of the upper surface 122 of the semiconductor wafer 114 and the surface level 124 of material 126. The sensory system 120 includes one or more sensors 128, 130 comprised of respective transmitters 132, 134 and receivers 136, 138. The measurements from the various levels are used to form a relatively precise layer of, for example, an encapsulant material on the upper surface 122 of the semiconductor wafer 114. Changes in the relative levels of surfaces 122 and 124 are coordinated through movements in the height of a platform 140 and/or through the movement of a material displacement piston 142.

FIG. 10 schematically depicts various components, and operation, of an exemplary stereolithography system 150 to facilitate the reader's understanding of the technology employed in implementation of the method of the present invention, although those of ordinary skill in the art will understand and appreciate that apparatus of other designs and manufacture may be employed in practicing the method of the present invention. Various aspects of stereolithography apparatus for implementation of the method of the present invention, as well as operation of such apparatus, are described in great detail in United States Patents assigned to 3D Systems, Inc. of Valencia, Calif., such patents including, without limitation, U.S. Pat. Nos. 4,575,330; 4,929,402; 4,996,010; 4,999,143; 5,015,424; 5,058,988; 5,059,021; 5,059,359; 5,071,337; 5,076,974; 5,096,530; 5,104,592; 5,123,734; 5,130,064; 5,133,987; 5,141,680; 5,143,663; 5,164,128; 5,174,931; 5,174,943; 5,182,055; 5,182,056; 5,182,715; 5,184,307; 5,192,469; 5,192,559; 5,209,878; 5,234,636; 5,236,637; 5,238,639; 5,248,456; 5,256,340; 5,258,146; 5,267,013; 5,273,691; 5,321,622; 5,344,298; 5,345,391; 5,358,673; 5,447,822; 5,481,470; 5,495,328; 5,501,824; 5,554,336; 5,556,590; 5,569,349; 5,569,431; 5,571,471; 5,573,722; 5,609,812; 5,609,813; 5,610,824; 5,630,981; 5,637,169; 5,651,934; 5,667,820; 5,672,312; 5,676,904; 5,688,464; 5,693,144; 5,695,707; 5,711,911; 5,776,409; 5,779,967; 5,814,265; 5,850,239; 5,854,748; 5,855,718; 5,855,836; 5,885,511; 5,897,825; 5,902,537; 5,902,538; 5,904,889; 5,943,235; and 5,945,058. The disclosure of each of the foregoing patents is hereby incorporated herein by this reference.

With continued reference to FIG. 10 and as noted above, a 3-D CAD drawing of a subsequent object to be fabricated in the form of a data file is placed in the memory of a controller 152 controlling the operation of stereolithography system 150 if controller 152 is not a CAD computer in which the original object design is effected. In other words, an object design may be effected in a first computer in an engineering or research facility and the data files transferred via wide or local area network, tape, disc, CD-ROM, or otherwise as known in the art to controller 152 of stereolithography system 150 for object fabrication.

The data is preferably formatted in an STL (for STereoLithography) file, STL being a standardized format employed by a majority of manufacturers of stereolithography equipment. Fortunately, the format has been adopted for use in many solid-modeling CAD programs, so translation from another internal geometric database format is often unnecessary. In an STL file, the boundary surfaces of an object are defined as a mesh of interconnected triangles.

Stereolithography system 150 also includes a reservoir 154 (which may comprise a removable reservoir interchangeable with others containing different materials) of an unconsolidated material 156 to be employed in fabricating the intended subsequent object. In the currently preferred embodiment, the unconsolidated material 156 is a liquid, photo-curable polymer, or “photopolymer,” that cures in response to light in the UV wavelength range. The surface level 158 of unconsolidated material 156 is automatically maintained at an extremely precise, constant magnitude by devices, such as the piston 142 (FIG. 9) known in the art and responsive to output of sensors within system 150 and preferably under control of controller 152. A support platform or elevator 160, precisely vertically movable in fine, repeatable increments responsive to control of controller 152, is located for movement downward into and upward out of material 156 in reservoir 154.

A structure may be fabricated on a substrate, such as a semiconductor wafer 144 disposed on platform 160. The semiconductor wafer 144 may be secured to the platform 160 through vacuum pressure, adhesive, other otherwise and may be further secured thereto by way of one or more base supports (not shown) to prevent lateral movement of, the substrate relative to the platform 160 particularly when a so-called “recoater” blade 172 is employed to form a layer of material on a substrate, such as semiconductor wafer 144 disposed thereon.

Stereolithography system 150 has a UV wavelength range laser plus associated optics and galvanometers (collectively identified as laser 162) for controlling the scan of laser beam 166 in the X-Y plane across the semiconductor wafer 144 fixed about the platform 160. Laser 162 has associated therewith a mirror 164 to reflect beam 166 downwardly as beam 168 toward surface 170 of semiconductor wafer 144. Beam 168 is traversed in a selected pattern in the X-Y plane, that is to say, in a plane parallel to surface 170, by initiation of the galvanometers under control of controller 152 to at least partially cure, by impingement thereon, selected portions of material 156 disposed over surface 170 to at least a partially consolidated (e.g., semisolid) state. The use of mirror 164 lengthens the path of the laser beam, effectively doubling same, and provides a more vertical beam 168 than would be possible if the laser 162 itself were mounted directly above surface 170, thus enhancing resolution.

Data from the STL files resident in controller 152 is manipulated to build a subsequent object such as an encapsulating layer as shown in various configurations which are illustrated in FIGS. 2-7 one layer at a time. Accordingly, the data mathematically representing one or more of the objects to be fabricated are divided into subsets, each subset representing a slice or layer of the object. The division of data is effected by mathematically sectioning the 3-D CAD model into at least one layer, a single layer or a “stack” of such layers representing the object. Each slice may be from about 0.0001 to about 0.0300 inch thick. As mentioned previously, a thinner slice promotes higher resolution by enabling better reproduction of fine vertical surface features of the object or objects to be fabricated.

Because the various embodiments of the present invention build a subsequent structure, such as encapsulant layer, beginning at a defined surface of an existing underlying structure, an example of which is a semiconductor wafer. Therefore, the underlying structure provides the support or base structure for the underlying or subsequent structure.

By way of disclosure of one operational stereolithographic process configuration, the operational parameters for stereolithography system 150 are set to adjust the size (diameter if circular) of the laser light beam used to cure material 156. In addition, controller 152 automatically checks and, if necessary, adjusts by means known in the art the surface level 158 of material 156 in reservoir 154 to maintain same at an appropriate focal length for laser beam 168. U.S. Pat. No. 5,174,931, referenced above and previously incorporated herein by reference, discloses one suitable level-control system. Alternatively, the height of mirror 164 may be adjusted responsive to a detected surface level to cause the focal point of laser beam 168 to be located precisely at surface level 158 of material 156 if surface level 158 is permitted to vary, although this approach is more complex. Platform 160 with semiconductor wafer 144 attached thereto may then be submerged in material 156 in reservoir 154 to a depth equal to the thickness of one layer or slice of the object to be formed, and the liquid surface level 158 is readjusted as required to accommodate material 156 displaced by submergence of platform 160 and semiconductor wafer 144. Laser 162 is then activated so laser beam 168 will scan unconsolidated (e.g., liquid or powdered) material 156 disposed over the surface 170 of semiconductor wafer 144 to at least partially consolidate (e.g., polymerize to at least a semisolid state) material 156 at selected locations, defining the boundaries of a first layer. Platform 160 is then lowered by a distance equal to a thickness of a second layer and laser beam 168 scanned over selected regions of the surface of material 156 to define and fill in the second layer while simultaneously bonding the second layer to the first. The process may then be repeated, as often as necessary, layer by layer, until the subsequent structure, such as an encapsulant layer, is completed. The number of layers required to erect the structure or object to be formed depends upon the height of the object or objects to be formed and the desired layer thickness. The layers of a stereolithographically fabricated structure with a plurality of layers may have different thicknesses.

If a recoater blade 172 is employed, the process sequence is somewhat different. In this instance, surface 170 of the semiconductor wafer 144 on platform 160 is lowered into unconsolidated (e.g., liquid) material 166 below surface level 158 a distance greater than a thickness of a single layer of material 156 to be cured, then raised above surface level 158 until a substrate disposed thereon, or a structure being formed on platform 160 is precisely one layer's thickness below blade 172. Blade 172 then sweeps horizontally over the semiconductor wafer 144 on platform 160 or (to save time) at least over a portion thereof on which one or more objects are to be fabricated to remove excess material 156 and leave a film of precisely the desired thickness. Platform 160 is then lowered so that the surface of the film and surface level 158 are coplanar and the surface of the unconsolidated material 156 is still. Laser 162 is then initiated to scan with laser beam 168 and define the first layer. The process is repeated, layer by layer, to define each succeeding layer and simultaneously bond same to the next lower layer until all of the layers of the object or objects to be fabricated are completed. A more detailed discussion of this sequence and apparatus for performing same is disclosed in U.S. Pat. No. 5,174,931, previously incorporated herein by reference.

As an alternative to the above approach to preparing a layer of material 156 for scanning with laser beam 168, a layer of unconsolidated (e.g., liquid) material 156 may be formed on surface 170 of the semiconductor wafer 144 disposed on platform 160, or on one or more objects being fabricated by lowering platform 160 to flood material 156 over surface 170, over a substrate disposed thereon, or over the highest completed layer of the object or objects being formed, then raising platform 160 and horizontally traversing a so-called “meniscus” blade horizontally over the substrate, such as semiconductor wafer 144 or each of the objects being formed. Laser 162 is then initiated and a laser beam 168 scanned over the layer of unconsolidated material to define at least the boundaries of the solid regions of the next higher layer of the object or objects being fabricated.

Yet another alternative to layer preparation of unconsolidated (e.g., liquid) material 156 is to merely lower the semiconductor wafer 144 on platform 160 to a depth equal to that of a layer of material 156 to be scanned, and to then traverse a combination flood bar and meniscus bar assembly horizontally over a substrate disposed on platform 160, or one or more objects being formed to substantially concurrently flood material 156 thereover and to define a precise layer thickness of material 156 for scanning.

All of the foregoing approaches to liquid material flooding and layer definition and apparatus for initiation thereof are known in the art and are not material to practice of the present invention, so no further details relating thereto will be provided herein.

In practicing the present invention, a commercially available stereolithography apparatus operating generally in the manner as that described above with respect to stereolithography system 150 of FIG. 10 is preferably employed, but with further additions and modifications as hereinafter described for practicing the method of the present invention. For example and not by way of limitation, the SLA-250/50HR, SLA-5000, SLA-7000 and SLA-3500 stereolithography systems, each offered by 3D Systems, Inc, of Valencia, Calif. and stereolithography systems available from Sony Precision Technology America, Inc. of Tokyo, Japan, are suitable for modification. Photopolymers believed to be suitable for use in practicing the present invention include Cibatool SL 5170, SL 5210, SL 5530 and SL 7510 resins available from Ciba Specialty Chemicals Company as well as SI-40 resin available from RPC, a wholly owned subsidiary of 3D Systems, Inc., of Switzerland.

By way of example and not limitation, the layer thickness of material 156 to be formed, for purposes of the invention, may be on the order of about 0.0001 to 0.0300 inch, with a high degree of uniformity. It should be noted that different material layers may have different heights, so as to form a structure of a precise, intended total height or to provide different material thicknesses for different portions of the structure. The size of the laser beam “spot” impinging on surface level 158 of material 156 to cure same may be on the order of 0.001 inch to 0.008 inch. Resolution is preferably ±0.0003 inch in the X-Y plane (parallel to surface 170) over at least a 0.5 inch×0.25 inch field from a center point, permitting a high resolution scan effectively across a 1.0 inch×0.5 inch area. Of course, it is desirable to have substantially this high a resolution across the entirety of surface 170 of semiconductor 144 on platform 90 to be scanned by laser beam 168, such area being termed the “field of exposure,” such area being substantially coextensive with the vision field of a machine vision system employed in the apparatus of the invention as explained in more detail below. The longer and more effectively vertical the path of laser beam 166, 168, the greater the achievable resolution.

Referring again to FIG. 10, it should be noted that stereolithography system 150 useful in the method of the present invention includes the sensing system 120 of FIG. 9 which measures both the starting position or level of the upper surface 170 of the semiconductor wafer 144 and the surface level 158 of the material 156. The sensing system 120 includes one or more sensors 128, 130 comprised of respective transmitters 132, 134 and receivers 136, 138. The measurements from the various levels are used to form a relatively precise layer of, for example, an encapsulant material on the upper surface 170 of the semiconductor wafer 144.

Processing in accordance with the one or more methods of the present invention for selectively depositing a material on a workpiece, such as a semiconductor wafer 144, includes securing the semiconductor wafer 144 to the platform 160 or other support structure. The location of the top or upper surface 170 of the semiconductor wafer 144 is measured and identified as a starting or reference point upon which the formation of a structures, such as an encapsulant, is formed. A portion of unconsolidated material 200 is deposited upon the upper surface 170 of either the semiconductor wafer 144 or a previously consolidated layer of material 156. A thickness of unconsolidated material may be determined by measuring the surface level 158 of unconsolidated material 156 and with reference to the previously identified upper surface 170 of the semiconductor wafer. The thickness of the unconsolidated material 200 is also relative to the distance of movement of the platform 160 when submerged into the material 156. At least a portion of the unconsolidated material is then consolidated according to a defined pattern on the semiconductor wafer 144 or upon a previously consolidated layer on the semiconductor wafer 144. The steps of depositing, measuring and consolidating are then repeated until the thickness of the material corresponds to a desired or preselected thickness.

While the present invention has been disclosed in terms of certain preferred embodiments, those of ordinary skill in the art will recognize and appreciate that the invention is not so limited. Additions, deletions and modifications to the disclosed embodiments may be effected without departing from the invention claimed herein. Similarly, features from one embodiment may be combined with those of another while remaining within the scope of the invention.

1. A system for selectively depositing a material on a previously formed workpiece, comprising:
a platform for supporting the workpiece during a deposition process;
a sensing system for measuring an upper surface of the workpiece and a surface level of a material deposited on the upper surface of the workpiece until the surface level of the material corresponds to a specific thickness of the material; and
a deposition system for depositing the material on the workpiece to the specific thickness as monitored by the sensing system.

2. The system of claim 1, wherein the deposition system is a spin-coating deposition system.

3. The system of claim 2, wherein the sensing system includes a sensor for both measuring the upper surface of the workpiece and for monitoring the surface level of the material deposited on the upper surface of the workpiece.

4. The system of claim 2, wherein the sensing system includes a first sensor for measuring the upper surface of the workpiece and a second sensor for monitoring the surface level of the material deposited on the upper surface of the workpiece.

5. The system of claim 1, wherein the deposition system is a stereolithographic deposition system.

6. The system of claim 5, wherein the sensing system includes a sensor for both measuring the upper surface of the workpiece and for monitoring the surface level of the material deposited on the upper surface of the workpiece.

7. The system of claim 5, wherein the sensing system includes a first sensor for measuring the upper surface of the workpiece and a second sensor for monitoring the surface level of the material deposited on the upper surface of the workpiece.

8. The system of claim 1, wherein the workpiece is a semiconductor wafer.

9. A selective deposition system for depositing a material at selective locations on a previously formed workpiece, comprising:
a controller;
a platform for movably supporting in a Z direction the workpiece during a layer by layer deposition of the material at the selective locations on the workpiece;
a reservoir for retaining the material and submerging the platform and the workpiece during the layer by layer deposition;
an X/Y scanning laser responsive to the controller for exposing a portion of the material corresponding to the selective locations for a current deposition layer about the workpiece; and
at least one sensing system responsive to the controller for determining a workpiece surface level when the workpiece is supported by the platform and for determining a surface level of the material formed on the workpiece.

10. The system of claim 9, wherein the at least one sensing system is further configured for determining a material level within the reservoir, the material level corresponding to the surface level of the material formed on the workpiece.

11. The system of claim 10, wherein the controller is further configured to orient the workpiece near the material level for initializing the layer by layer deposition of the workpiece.

12. The system of claim 9, wherein the controller is further configured to continuously control the platform and the laser while monitoring the at least one sensing system until the material on the workpiece corresponds to a specific thickness of the material.

13. The system of claims 9, wherein the at least one sensing system comprises a first sensing system and a second sensing system with each including at least one transmitter and at least one receiver.

14. The system of claim 9, wherein the workpiece is a semiconductor wafer including at least one semiconductor die.

15. The system of claim 14, wherein the material formed on the semiconductor wafer is formed on at least an active surface thereof.

16. A method for selectively depositing a material on a workpiece, comprising:
securing a workpiece to a platform;
measuring a level of a top surface of the workpiece to determine a starting point for depositing an unconsolidated material thereon;
depositing the unconsolidated material on the workpiece;
measuring a level of an upper surface of the unconsolidated material deposited on the workpiece to determine a thickness of the material on the workpiece from the respective levels of the top surface of the workpiece and the level of the upper surface of the material;
consolidating at least a portion of the unconsolidated material according to a defined pattern on the workpiece when the thickness of the material on the workpiece does not exceed a preselected thickness; and
repeating the depositing, measuring and consolidating of the upper surface of the material until the thickness of the material corresponds to the preselected thickness.

17. The method of claim 16, wherein the depositing comprises spin-coating the workpiece with at least a portion of the material.

18. The method of claim 16, wherein the depositing comprises coating the workpiece with the unconsolidated material, and the consolidating comprises exposing selected portions of the unconsolidated material over the workpiece to form the material on the workpiece.

19. The method of claim 18, wherein the coating comprises submerging the platform and the workpiece attached thereto into a volume of the unconsolidated material.

20. The method of claim 18, wherein the coating comprises applying the unconsolidated material to the workpiece with a recoater blade across the upper surface of the material on the workpiece.

21. The method of claim 16, wherein the measuring the level of the top surface of the workpiece, comprises:
transmitting a signal from a transmitter toward the top surface of the workpiece;
receiving the signal at a receiver as reflected by the top surface of the workpiece; and
calculating the level of the top surface upon which the at least a portion of the material is deposited.

22. The method of claim 16, wherein the measuring the level of the upper surface of the material as deposited on the workpiece, comprises:
transmitting a signal from a transmitter toward the upper surface of the material;
receiving the signal at a receiver as reflected by the upper surface of the material; and
calculating the thickness of the material deposited on the workpiece to determine the thickness of the material on the workpiece.

23. A method for fabricating a semiconductor assembly, comprising:
measuring a level of a top surface to determine a deposition starting point of at least one semiconductor die integral with a semiconductor wafer;
depositing a layer of an encapsulant material in an unconsolidated form beginning at the deposition starting point on the at least one semiconductor die;
measuring an upper surface of the layer of the encapsulant material deposited on the at least one semiconductor die to determine a thickness of the material on the at least one semiconductor die;
consolidating at least a portion of the encapsulant material in the unconsolidated form according to a defined pattern on the at least one semiconductor die when the thickness of the material on the at least one semiconductor die does not exceed a preselected thickness; and
repeating the depositing, measuring and consolidating of another layer of the encapsulant material over a previous layer until the thickness of the encapsulant material is substantially equal to the predetermined thickness.

24. The method of claims 23, wherein the depositing comprises spin-coating the semiconductor wafer with at least a portion of the encapsulant material in an unconsolidated form.

25. The method of claim 23, wherein the depositing comprises:
coating the semiconductor wafer with the encapsulant material in an unconsolidated form; and
exposing selected portions of the encapsulant material over the semiconductor wafer to form the layer of the encapsulant material on the at least one semiconductor die.

26. The method of claim 25, wherein the coating comprises submerging the semiconductor wafer into a volume of the encapsulant material in an unconsolidated form.

27. The method of claims 25, wherein the coating comprises applying the uncured portion of the encapsulant material to the semiconductor wafer with a recoater blade across the upper surface of the layer of the encapsulant material on the semiconductor wafer.

28. The method of claim 23, wherein the measuring the level of the top surface of the at least one semiconductor die, comprises:
transmitting a signal from a transmitter toward the top surface of the at least one semiconductor die;
receiving the signal at a receiver as reflected by the top surface of the at least one semiconductor die; and
calculating the level of the top surface upon which the at least a portion of the encapsulant material is deposited.

29. The method of claim 23, wherein the measuring the upper surface of the encapsulant material deposited on the at least one semiconductor die, comprises:
transmitting a signal from a transmitter toward the upper surface of the encapsulant material;
receiving the signal at a receiver as reflected by the upper surface of the encapsulant material; and
calculating the thickness of the encapsulant material as deposited on the at least one semiconductor die to determine the thickness of the material on the at least one semiconductor die.
